(19) United States
(12) Patent Application Publication
(10) Pub. No.: US 2026/0302767 A1
(43) Pub. Date: Oct. 1, 2026

(54) LIGHTNING SURGE COUNTERMEASURE DEVICE AND POWER FEED SYSTEM

(71) Applicant: NTT, Inc., Tokyo (JP)

(72) Inventors: Naomichi NAKAMURA, Tokyo (JP); Naoki HANAOKA, Tokyo (JP); Yuji HIGUCHI, Tokyo (JP); Yuji SUNADA, Tokyo (JP); Toru TANAKA, Tokyo (JP)

(21) Appl. No.: 19/480,503

(22) PCT Filed: Jun. 9, 2023
(86) PCT No.: PCT/JP2023/021616

§ 371 Date: Oct. 31, 2025

(51) Int. Cl. H02H 9/04

(52) U.S. Cl. CPC H02H 9/04

(57) ABSTRACT

A lightning surge countermeasure device used for a DC feed system includes a first impedance unit for increasing an impedance on either polarity side of a positive electrode and a negative electrode, a positive-electrode-side lightning arrester; and a negative-electrode-side lightning arrester.

### TECHNICAL FIELD

The present invention relates to a technology for lightning surge protection for a DC feed system.

### BACKGROUND ART

As countermeasures against a lightning surge for a DC (Direct-Current) feed system (for example, a DC/DC converter), it is known to install a surge protective device (SPD) such as a zinc oxide varistor (hereinafter referred to as a varistor) and the like on an output side (which a lightning surge enters) of the DC feed system.

The surge protection device may be referred to as a lightning arrester.

For example, by installing varistors described in Non-Patent Literature 1 between a positive electrode and a ground electrode of a DC feed system and between a negative electrode and a ground electrode of the DC feed system, a lightning surge that has entered from a cable connected to the DC feed system can be released to the ground via the varistors.

### CITATION LIST

### Non-Patent Literature

Non-Patent Literature 1:

https://industrial.panasonic.com/jp/products/pt/surge-components (Retrieved on May 31, 2023)

Non-Patent Literature 2: https://article.murata.com/ja-jp/article/basics-of-noise-countermeasures-lesson-6 (Retrieved on May 31, 2023)

### SUMMARY OF INVENTION

### Technical Problem

However, in the lightning surge countermeasure in the related art, there is a problem that a failure may occur in an internal circuit of a DC feed system when the lightning surge enters a cable connected to the DC feed system. That is, the technique of the related art using a varistor or the like has a problem of not being very effective as a countermeasure against a lightning surge.

The present invention has been made in view of the above circumstances, and an object of the present invention is to enhance an effect of countermeasures against a lightning surge in a DC feed system.

### Solution to Problem

According to the disclosed technology, there is provided a lightning surge countermeasure device used for a DC feed system. The lightning surge countermeasure device includes: a first impedance unit configured to increase an impedance on either polarity side of a positive electrode and a negative electrode; a positive-electrode-side lightning arrester; and a negative-electrode-side lightning arrester.

### Advantageous Effects of Invention

According to the disclosed technology, it is possible to enhance the effect of countermeasures against a lightning surge in a DC feed system.

### BRIEF DESCRIPTION OF DRAWINGS

FIG. 1 is a diagram illustrating a configuration example of a feed system when a varistor is provided as a countermeasure against a lightning surge.

FIG. 2 is a diagram illustrating a problem.

FIG. 3 is a diagram illustrating a problem.

FIG. 4 is a diagram illustrating a problem.

FIG. 5 is a diagram illustrating Configuration Example 1 of the feed system according to the embodiment of the present invention.

FIG. 6 is a diagram illustrating Configuration Example 2 of the feed system according to the embodiment of the present invention.

FIG. 7 is a diagram illustrating a configuration example of a lightning surge countermeasure device 100.

### DESCRIPTION OF EMBODIMENTS

Hereinafter, embodiments of the present invention (present embodiment) will be described with reference to the drawings. The embodiments to be described below are merely exemplary, and embodiments to which the present invention is applied are not limited to the following embodiment. Hereinafter, a varistor is used as an example of a lightning arrester (surge protection device), but the technology according to the present invention is also applicable to a case in which a lightning arrester other than a varistor is used.

Hereinafter, first, a technique and problems of the related art will be described in detail. Thereafter, a technique according to the present embodiment will be described in detail. In the related art, the techniques disclosed in Non-Patent Literatures 1 and 2 themselves are publicly known, but the following description content of the related art and the following description content of the problems are not publicly known.

### Technique of Related Art

As described above, it is known that a varistor is installed on an output side (which a lightning surge enters) of a DC feed system, such as a DC/DC converter and the like, as countermeasures against a lightning surge in the DC feed system.

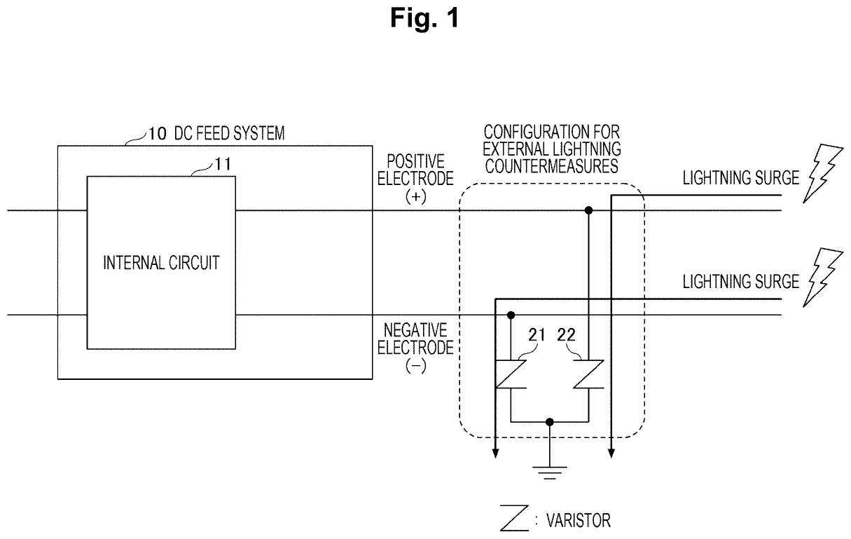

FIG. 1 illustrates a configuration example of a feed system when a varistor is provided as a countermeasure against a lightning surge. In the configuration example illustrated in FIG. 1, on the output side of the DC feed system 10 including an internal circuit 11, a varistor 22 is installed between the positive electrode (any point on a cable on the positive electrode side) and the ground electrode, and a varistor 21 is installed between the negative electrode (any point on the cable on the positive electrode side) and the ground electrode. Accordingly, the lightning surge that has entered from the cable can be released to the ground via the varistors 21 and 22.

### Problem

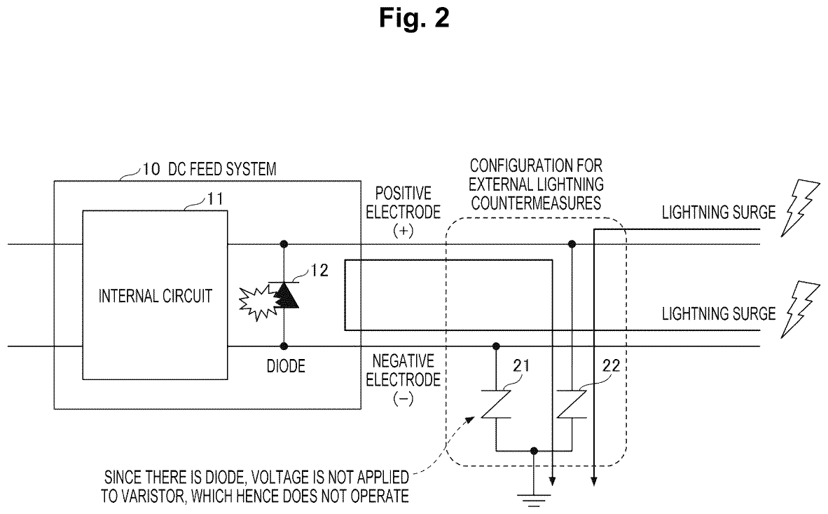

However, when the internal circuit on the output side of the DC feed system 10 (the same applies to the input side) is asymmetric, a problem illustrated in FIG. 2 occurs in countermeasures of installing the varistors 21 and 22 between the positive electrode and the ground electrode and between the negative electrode and the ground electrode as illustrated in FIG. 1.

FIG. 2 illustrates a diode 12 connected to the internal circuit 11 in the DC feed system 10. The diode 12 is one of a plurality of internal circuits in the DC feed system 10. The diode 12 may be referred to as an “internal circuit 12”. The internal circuit 11 and the diode 12 may be collectively referred to as an “internal circuit”. In the example of FIG. 2, the anode of the diode 12 is connected to the negative electrode, and the cathode is connected to the positive electrode.

As illustrated in FIG. 2, when a lightning surge enters both the cable on the positive electrode side and the cable on the negative electrode side, the varistor 21 installed between the negative electrode and the ground electrode does not operate, and the lightning surge which enters the cable on the negative electrode side flows into the varistor 22 on the positive electrode side via the diode 12 of the internal circuit. Accordingly, the internal circuit may be destroyed, which results in failure of the DC feed system 10.

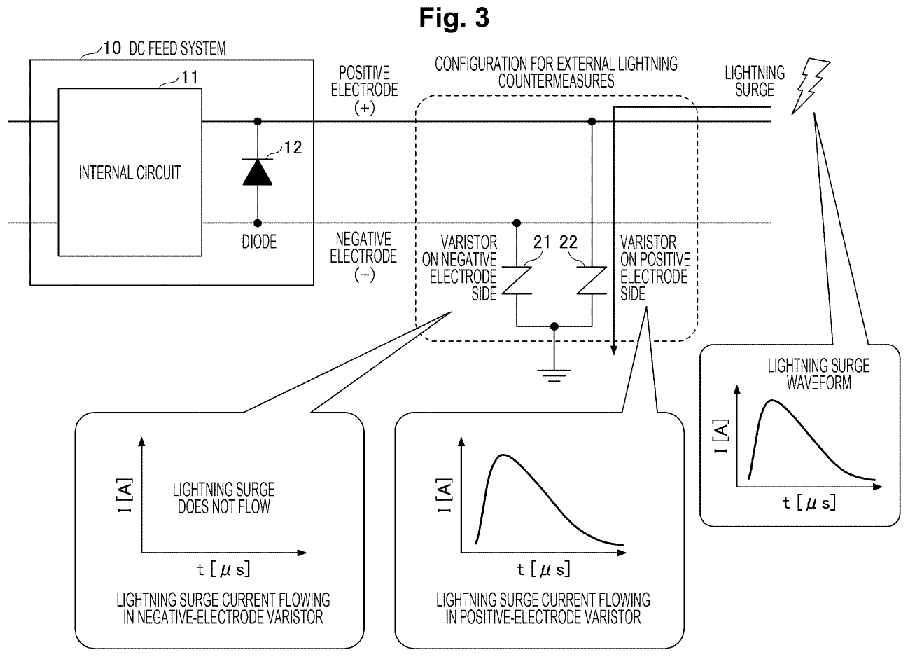

However, as illustrated in FIG. 3, when the lightning surge enters only the cable on the positive electrode side, the lightning surge current does not flow into the diode 12. Therefore, the varistor 21 on the positive electrode side operates normally. Accordingly, the internal circuit is not destroyed by the lightning surge, and the DC feed system 10 does not fail.

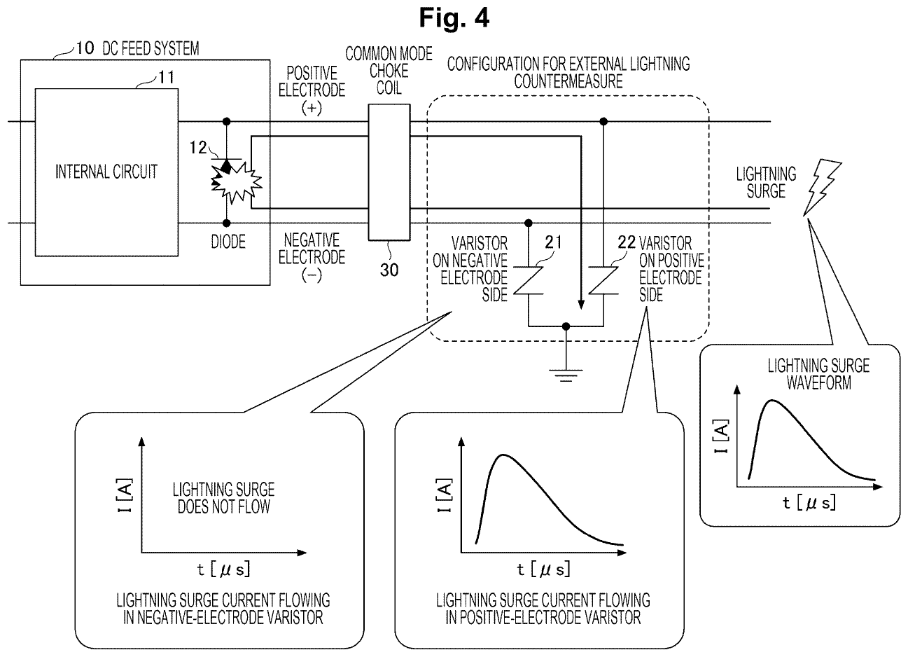

To solve the problem illustrated in FIG. 2, as illustrated in FIG. 4, a common mode choke coil 30 disclosed in Non-Patent Literature 2 is disposed between the internal circuit 12 and the varistors 21 and 22, so that the varistors 21 and 22 can be effectively operated. However, in the configuration of FIG. 4 including the common mode choke coil 30, the effect cannot be obtained unless a lightning surge enters not only the cable on the positive electrode side but also the cable on the negative electrode side.

In particular, as illustrated in FIG. 4, when a lightning surge (normal mode) enters only the cable on the negative electrode side, the lightning surge passes through the common mode choke coil 30, destroys the diode 12, and flows into the varistor 22 on the positive electrode side. When the diode 12 is damaged, the DC feed system fails.

Hereinafter, a configuration according to the present embodiment for solving the above problem will be described in detail.

### Configuration Example 1

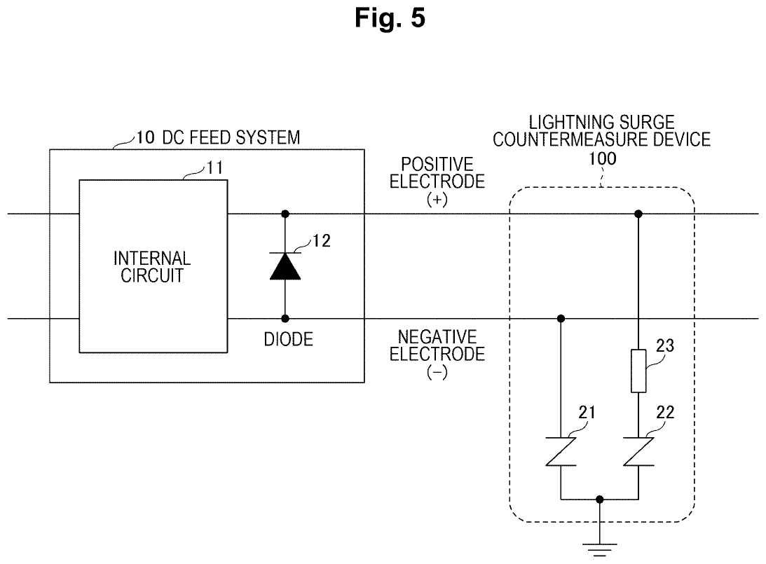

FIG. 5 illustrates Configuration Example 1 of a feed system according to the present embodiment. Configuration Example 1 is a configuration in which an impedance unit 23 is added between the positive electrode and the ground electrode, as compared with the configuration illustrated in FIG. 2.

That is, the diode 12 (internal circuit 12) is included in the DC feed system 10. A positive-electrode-side cable and a negative-electrode-side cable extend from the DC feed system 10.

The varistor 22 is provided between the positive electrode and the ground electrode, the varistor 21 is provided between the negative electrode and the ground electrode, and the impedance unit 23 is provided between the positive electrode and the ground electrode. In the example of FIG. 5, the impedance unit 23 is provided between the positive electrode and the varistor 22, but the impedance unit 23 may be provided between the varistor 22 and the ground electrode.

A configuration (portion) including the varistors 21 and 22 and the impedance unit 23 is referred to as the lightning surge countermeasure device 100.

The impedance unit 23 may be any type, as long as the impedance unit 23 has a function of increasing impedance on the positive electrode side. “Increasing the impedance on the positive electrode side” means that “the impedance on the positive electrode side when the impedance unit 23 is present” is made higher than “the impedance on the positive electrode side when there is no impedance unit 23”. The “impedance on the positive electrode side” is, for example, an impedance between the positive electrode and the ground electrode.

For example, the impedance unit 23 is an element that increases impedance. The element is, for example, a resistor, a coil, or both a resistor and a coil.

The impedance unit 23 may have a configuration in which the impedance is increased by deforming a circuit pattern. Deforming the circuit pattern means, for example, thinning a base circuit pattern on the positive electrode side (that is, reducing the width of a conductor included in the pattern), lengthening the base circuit pattern (increasing the length of the conductor included in the pattern), or forming the conductor in a zigzag form or a U shape by guaranteeing a sufficient separation distance between the conductors in the base circuit pattern.

In FIG. 5, the base circuit pattern is a pattern of a circuit electrically connected between the positive electrode and the ground electrode.

As described above, instead of deforming the circuit pattern or in addition to deforming the circuit pattern, a cable for connecting the varistor 22 between the positive electrode and the ground electrode may be thinned, or the shape of the cable may be a winding shape. Another method may be used as long as the impedance unit 23 can be realized.

As illustrated in FIG. 5, by providing the impedance unit 23, it is possible to make it difficult for a lightning surge that has entered from the negative electrode side to flow from the varistor 22 on the positive electrode side to the ground via the inside of the DC feed system 10.

The magnitude of the impedance in the impedance unit 23 may be set in consideration of current tolerance or dielectric strength (voltage) between the positive electrode and the negative electrode.

In the example of FIG. 5, the impedance unit 23 is provided on the positive electrode side, but this is exemplary. The impedance unit may be provided not on the positive electrode side but on the negative electrode side, in accordance with the asymmetry characteristic in the internal circuit.

### Configuration Example 2

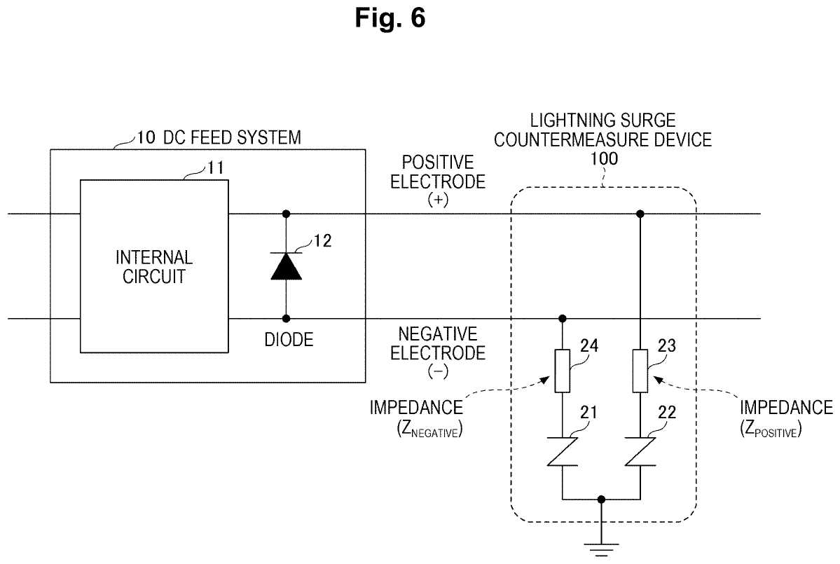

FIG. 6 illustrates Configuration Example 2 of the system according to the present embodiment. As illustrated in FIG. 6, Configuration Example 2 is a configuration in which an impedance unit 24 for increasing impedance on the negative electrode side (impedance between the negative electrode and the ground electrode) is added between the negative electrode and the ground electrode, as compared with Configuration Example 1 (FIG. 5).

A method of realizing the impedance unit 24 is the same as the method of realizing the impedance unit 23, and has been described in Configuration Example 1. That is, an element may be used as the impedance unit 24, a deformation of a circuit pattern may be used, a deformation of a connection cable may be used, or another method may be used.

In the example of FIG. 6, the impedance unit 24 is provided between the negative electrode and the varistor 21, but the impedance unit 24 may be provided between the varistor 21 and the ground electrode.

As in Configuration Example 2, when the impedance units (which increase impedance) are disposed on both the positive electrode side and the negative electrode side, a difference is created between the impedance on the positive electrode side and the impedance on the negative electrode side.

For example, when the impedance of the impedance unit 23 on the positive electrode side is set to Zₚₒₛᵢₜᵢᵥₑ and the impedance of the impedance unit 24 on the negative electrode side is set to Z_{negative}, the following relationship may be established.

$${Z}_{positive} > α \times {Z}_{negative}$$

α is, for example, a real number of 1 or more. a is a coefficient depending on a device as a countermeasure target and depends on, for example, dielectric strength (voltage) between the positive electrode and the negative electrode or a current tolerance. Alternatively, α may depend on the dielectric strength (voltage) between the positive electrode and the ground or between the negative electrode and the ground. α may be appropriately determined according to the feed system into which the lightning surge countermeasure device 100 is introduced.

As in Configuration Example 1, by making the impedance on the positive electrode side higher than the impedance on the negative electrode side in Configuration Example 2, it is possible to make it difficult for a lightning surge that has entered from the negative electrode side to flow from the varistor 22 on the positive electrode side to the ground through the inside of the DC feed system 10.

### Configuration Example of Lightning Surge Countermeasure Device 100

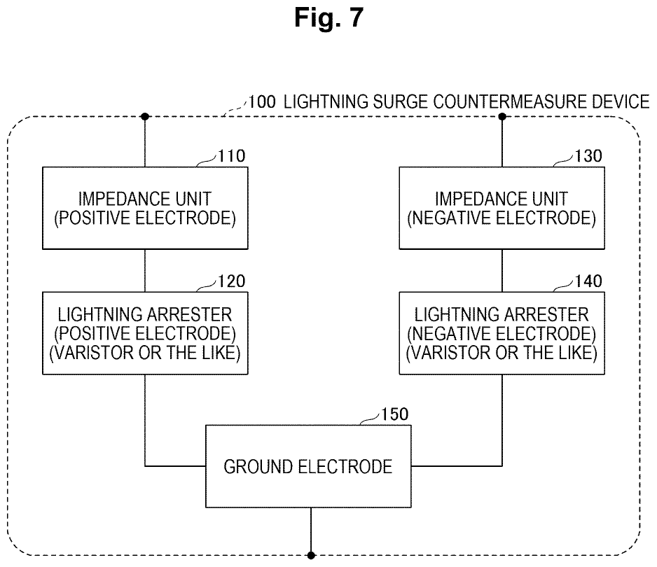

FIG. 7 illustrates a configuration example of the lightning surge countermeasure device 100. The configuration illustrated in FIG. 7 corresponds to a configuration in which a portion of the lightning surge countermeasure device 100 provided on the cable connected to the DC feed system in FIG. 6 is extracted.

As illustrated in FIG. 7, the lightning surge countermeasure device 100 includes a positive-electrode-side impedance unit 110, a positive-electrode-side lightning arrester 120, a negative-electrode-side impedance unit 130, a negative-electrode-side lightning arrester 140, and a ground electrode 150.

The impedance unit 23 illustrated in FIG. 6 is an example of the impedance unit 110, the impedance unit 24 is an example of the impedance unit 130, and the varistor 22 is an example of the lightning arrester 120 and an example of the varistor 22 and the lightning arrester 140.

In FIG. 7, only one of the impedance unit 110 on the positive electrode side or the impedance unit 130 on the negative electrode side need be provided.

### Effects of Embodiment

By introducing the above-described lightning surge countermeasure device 100, when a lightning surge enters both the positive-electrode-side cable and the negative-electrode-side cable, or even when a lightning surge enters only the negative-electrode-side cable, both the positive-electrode-side varistor and the negative-electrode-side varistor operate, and the lightning surge that has entered the negative-electrode side does not flow into the positive-electrode-side varistor through the internal circuit. Therefore, the countermeasure effect against the lightning surge can be enhanced.

With regard to the above embodiments, the following Clauses will be further disclosed.

### Clauses

### Clause 1

A lightning surge countermeasure device used for a DC feed system, the lightning surge countermeasure device including:
a first impedance unit configured to increase an impedance on either polarity side of a positive electrode and a negative electrode;
a positive-electrode-side lightning arrester; and
a negative-electrode-side lightning arrester.

### Clause 2

The lightning surge countermeasure device according to Clause 1, further including a second impedance unit configured to increase an impedance on a polarity side opposite to a polarity side on which the first impedance unit is provided.

### Clause 3

The lightning surge countermeasure device according to Clause 2, wherein a difference is provided between an impedance of the first impedance unit and an impedance of the second impedance unit.

### Clause 4

The lightning surge countermeasure device according to any one of Clauses 1 to 3, wherein on a polarity side on which the first impedance unit is provided, the first impedance unit is provided between a cable and the lightning arrester or between the lightning arrester and a ground electrode.

### Clause 5

A feed system including a DC feed system and the lightning surge countermeasure device according to any one of Clauses 1 to 4.

Although the present embodiments have been described above, the present invention is not limited to such specific embodiments, and various modifications and changes can be made within the scope of the gist of the present invention described in the claims.

### Reference Signs List

10 DC feed system
11 Internal circuit
12 Diode
21, 22 Varistor
23, 24 Impedance unit
100 Lightning surge countermeasure device
110 Impedance unit
120 Lightning arrester
130 Impedance unit
140 Lightning arrester
150 Ground electrode

1. A lightning surge countermeasure device used for a direct-current (DC) feed system, the lightning surge countermeasure device comprising:
a first impedance circuit configured to increase an impedance on either polarity side of a positive electrode and a negative electrode;
a positive-electrode-side lightning arrester; and
a negative-electrode-side lightning arrester.

2. The lightning surge countermeasure device according to claim 1, further comprising a second impedance circuit configured to increase an impedance on a polarity side opposite to a polarity side on which the first impedance circuit is provided.

3. The lightning surge countermeasure device according to claim 2, wherein a difference is created between an impedance of the first impedance circuit and an impedance of the second impedance circuit.

4. The lightning surge countermeasure device according to claim 1, wherein on a polarity side on which the first impedance circuit is provided, the first impedance circuit is provided between a cable and the lightning arrester or between the lightning arrester and a ground electrode.

5. A feed system comprising a DC feed system and the lightning surge countermeasure device according claim 1.
